(19) United States
(12) Patent Application Publication
(10) Pub. No.: US 2020/0263461 A1
(43) Pub. Date: Aug. 20, 2020

(54) MOBILE ACCOMMODATION, FRAMED WINDOW AND CLOSURE

(71) Applicant: Polyplastic Group B.V., Rotterdam (NL)

(72) Inventors: Joris Michiel Roukema, Bergschenhoek (NL); Jan Peter Veeneman, Bergschenhoek (NL)

(21) Appl. No.: 16/762,833

(22) PCT Filed: Nov. 12, 2018
(86) PCT No.: PCT/NL2018/050755

§ 371 Date: May 8, 2020

(30) Foreign Application Priority Data
Nov. 10, 2017 (NL) 2019882

(51) Int. Cl. E05B 83/44; E05C 3/04

(52) U.S. Cl. CPC E05B 83/44; E05B 17/0025; E05C 3/043

(57) ABSTRACT

Mobile accommodation comprising a wall (10) with a wall opening (5) in which an openable window is arranged, which window is provided with closing means for keeping the window in a closed position. The closing means comprise a closure (30) with a handle (34) which is connected for rotation about a pivot axis (III) to the window, and with a protrusion (35) which, in a first position of the closure round the pivot axis, is in closing co-action with a shoulder on the edge of the wall opening. In a second position of the handle about the pivot axis, the protrusion is disengaged from the shoulder in order to release the window. The pivot axis (III) makes an obtuse angle with the window, which angle opens toward a hinge side of the window. In the first position the handle is oriented substantially parallel (I) to the window and in the second position points at an acute angle (a) toward the hinge side of the window.

The present invention relates to a mobile accommodation comprising a wall with a wall opening in which an openable window is arranged, which window is provided with closing means for keeping the window in a closed position, wherein the closing means comprise a closure with a handle which is connected for rotation about a pivot axis to the window, and with a protrusion which, in a first position of the closure round the pivot axis, is in closing co-action with a shoulder on the edge of the wall opening and which, in a second position of the handle about the pivot axis, disengages the protrusion from the shoulder in order to release the window.

This relates particularly to a mobile accommodation in the form of a caravan or camper, also referred to as a motor home. The walls hereof are usually formed by sandwich panels of opposite hard shells with a foamed core. Wall openings are provided therein at a location where a window must eventually be present. With a view to a reliable and firm mounting base for a later fitting of a window in the wall opening, a wooden frame is usually provided around a periphery thereof in known mobile accommodations. This is placed between the outer shells of the wall and, with this in mind, the core is recessed accordingly. This relates not only to transparent windows but for instance also to translucent or transparent skylights, roof lights and the like. With a view to a desired possibility of ventilating the accommodation, such windows are provided with hanging and closing fittings intended for the purpose, including a closure to enable manipulation of the window.

Such a closure is normally mounted on the window and comprises a handle with which the closure can be operated. In known windows the handle always extends substantially parallel to the window, whereby a minimal intermediate space has to be maintained which will always provide sufficient space for the fingers between the handle and the window. The closure hereby protrudes relatively far inward at all times, which is not only perceived as being less than elegant, but moreover forms an obstacle to any window covering which is present and which thereby has to maintain a greater distance from the window.

The present invention has for its object, among others, to provide a mobile accommodation wherein the above stated drawback is obviated to at least significant extent.

In order to achieve the stated object a mobile accommodation of the type described in the preamble has the feature according to the invention that the pivot axis makes an obtuse angle with the window, which angle opens toward a hinge side of the window, and that in the first position the handle is oriented substantially parallel to the window and in the second position points at an acute angle toward the hinge side. The pivot axis of the handle is thus placed obliquely according to the invention instead of substantially perpendicularly of the window. The obtuse angle which this axis makes with the window opens toward the hinge side of the window, whereby the axis runs obliquely away from the hinge side. The handle which pivots around this axis will hereby move away from the window during an adjustment toward the open, second position. This then provides extra intermediate space between the closure and the window, while the handle lies relatively closely against the window in the closed, first position and can simply be lifted a little from this position in order to provide more and adequate grip. The closure can hereby be embodied with less intermediate space between the handle and the window in the closed position without actually losing utility and convenience of use. This does however provide the option of a more compact construction and closer placing of an optional window covering and a surrounding window casing.

In a preferred embodiment the mobile accommodation is characterized according to the invention in that the closure comprises a base part which is firmly connected to the window at a first interface, that the closure comprises a top part from which the handle extends, that the top part is connected for rotation about the pivot axis to the base part at a second interface, and that the second interface makes an acute angle with the first interface, which acute angle is at least substantially complementary to the obtuse angle of the pivot axis. The closure can thus be mounted with the base part flat against the window in a normal manner and the mutual interface with the top part provides for the angular adjustment of the pivot axis of the handle intended according to the invention.

A further particular embodiment of the mobile accommodation has the feature according to the invention that the closure comprises manually releasable locking means which fix the closure in the first position. The locking means provide the option of fixing and closing the window in a closed position. Not only are uninvited persons hereby kept out, this also ensures that the window remains closed during transport instead of being opened by vibration.

With a view to a simple and quick final assembly and hanging of the window in the wall opening of the accommodation, a further preferred embodiment of the mobile accommodation has the feature according to the invention that a casing frame surrounds the window, that the window is placed via the casing frame in the wall opening and that the casing frame comprises the shoulder with which the protrusion of the closure is in engagement in a closed position of the window. The window, provided with all necessary hanging and closing fittings, can thus be pre-mounted in the window frame and subsequently be placed and fixed together therewith in the wall opening. This saves considerable assembly time during the construction of the mobile accommodation.

The present invention also relates to such a framed window with a casing frame in which an openable window is pre-mounted together with hanging and closing fittings, and to a closure of the type as specified above. The invention will be further elucidated hereinbelow with reference to an exemplary embodiment and an accompanying drawing.

In the drawing:

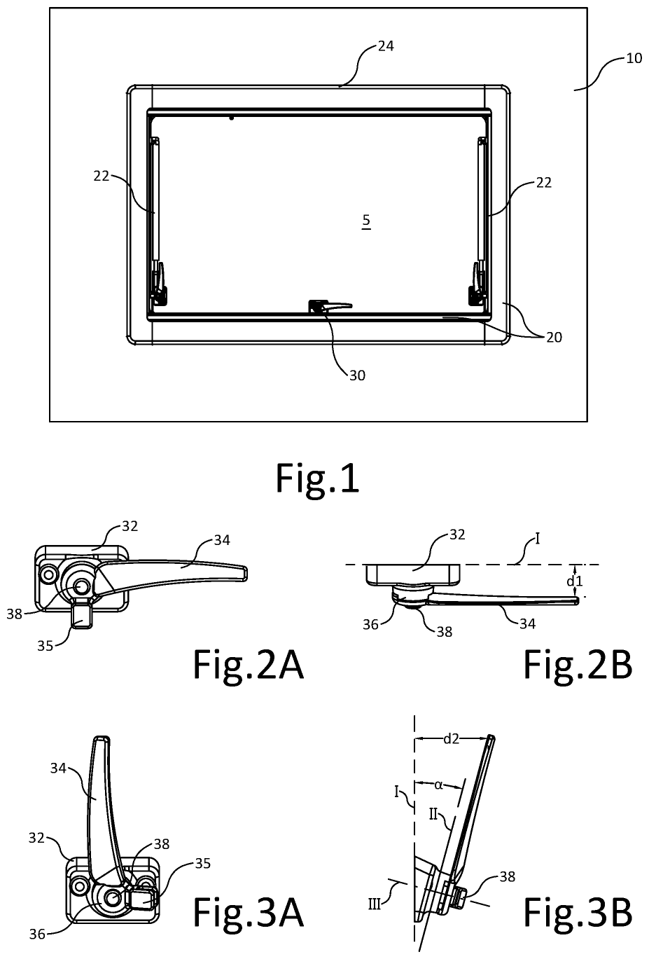

FIG. 1 shows a front view of an exemplary embodiment of a mobile accommodation according to the invention;

FIGS. 2A,B show respectively a front view and top view of an exemplary embodiment of a closure according to the invention as applied in the mobile accommodation of FIG. 1 in closed position; and

FIGS. 3A,B show respectively a front view and side view of the closure of FIGS. 2A and 2B in opened position.

It is otherwise noted here that the figures are purely schematic and not always drawn to (the same) scale. Some dimensions in particular may be exaggerated to greater or lesser extent for the sake of clarity. Corresponding parts are designated in the figures with the same reference numeral.

Shown in FIG. 1 is a part of a wall 10 of a mobile accommodation such as a caravan or camper. The wall typically comprises a sandwich construction of a hard inner shell and outer shell of for instance aluminium or a suitable plastic with a thickness of several millimetres, wherein the interior is optionally covered with a wood design or other decorative wall finish. For an effective thermal insulation both shells are separated from each other by a foamed core several centimetres thick, of for instance polyurethane or polystyrene. The further details of such a wall construction in a mobile accommodation such as a camper, caravan, yacht or the like is assumed sufficiently known to a person with ordinary skill in the art.

Recessed into wall 10 is a wall opening 5 at the location of which a window is arranged in this example. This is an openable window which is provided for this purpose with opening arms 22 and a closable latch 30 and which is provided on a hinge side with a line hinge 26. This window is pre-mounted together with these hanging and closing fittings 22,24,30 in a form-retaining, relatively stiff casing frame 20,25 arranged all round in wall opening 5. Such a window is for this reason normally referred to as a framed window. The shown part of casing frame 20 in which the window will be hung and with which the whole lies within wall opening 5 is in this example formed directly and in one whole as injection-moulded part from a suitable plastic such as polyethylene, polystyrene, polypropylene or ABS. Hereby possible is an exceptionally light but sufficiently stiff construction with a high measure of freedom of shape and design.

The invention is highly suitable for windows which will often take up a significant part of a surface area of the wall. With the thermal insulation value of such a window in mind, the window takes a double-walled form. The window is constructed here from a first sheet body and a second sheet body connected thereto which in a central part enclose a cavity therebetween but on their periphery make mutual contact with edge parts along which the two sheet bodies are attached to each other. The sheet bodies are more particularly formed from the same translucent plastic, in particular a transparent plastic from a group comprising polymethyl methacrylate (PMMA), polyethylene terephthalate glycol (PETG), polycarbonate (PC) and polyester.

Use is therefore made in this example of such a double-walled window with a set of transparent plastic sheet bodies of PMMA, wherein the outward facing pane is wholly flat and the inner pane is dish-shaped. The two panes hereby enclose at a central part an insulating cavity relative to each other. The two panes make contact with each other along their whole periphery with respective flat edge parts which are glued to each other to form an integral and stiff assembly. A sealing profile 8 of a suitable elastomer is arranged between the window and casing frame 20 for a watertight closure. Casing frame 20 comprises for this purpose a cavity for attachment of this seal.

In order to place the framed window the window is placed from outside in wall opening 5, wherein a flanged edge of the casing frame will drop over the edge part of wall 10 adjacent to opening 5. Provided beforehand therebetween is the adhesive bead which will already ensure a certain adhesion to wall 10, whereby the window remains in position in wall opening 5. The casing frame comprises all around on the periphery fixation means in the form of a series of mounting clamps of the type as further elucidated in a concurrent patent application of applicant.

In order to be able to close the window if desired, a closure 30 is provided thereon according to the present invention as shown in further detail in FIGS. 2A and 2B. The closure comprises a base part 32 with which the closure is attached directly to the inner pane of the window at a first interface I. The base part is provided for this purpose with bores for receiving corresponding screw members. The closure further comprises a top part 36 from which a handle 34 extends. Handle 34 is connected rigidly here to this top part 36, wherein top part 36 is in turn connected for rotation about a rotation axis III to the base part at a second interface II, see also FIG. 3B.

The interface I with the inner pane is shown schematically in FIG. 2B. In the closed first position of the closure shown here the handle 34 extends substantially parallel to interface I and handle 34 maintains a distance d1 relative to the interface, and thereby the inner pane. A protrusion 35 likewise formed on top part 35 closes here behind a shoulder (not further shown) extending from the inner edge of casing frame 20 so that in this situation the window cannot be opened and remains closed. In order to open the window the handle is pivoted upward, see FIG. 3A, whereby protrusion 35 is disengaged from the shoulder and the window is thereby released. The handle now points upward in the direction of the hinge side of the window with hinge 24.

As further shown in FIG. 3B, second interface II makes an acute angle with first interface I. In other words, pivot axis III thus lies obliquely of first interface I at an obtuse angle which is complementary to the angle between the two interfaces (i.e. s=90+α). Because of this oblique position of pivot axis III the handle 34 also lies at this angle to window I in the wholly upright position, see FIG. 3B, and handle 34 moves away from the window when the closure is opened. In the situation shown in FIGS. 3A and 3B the handle hereby maintains a distance d2 from the window which is significantly greater than the original intermediate space d1. The handle hereby now provides considerably more grip, while in the closed position the handle can lie relatively closely against the window. Closure 30 hereby does not protrude relatively very far inward in the closed position.

Although the invention has been further elucidated above with reference to only a single exemplary embodiment, it will be apparent that the invention is by no means limited thereto. On the contrary, many variations and embodiments are still possible within the scope of the invention for a person with ordinary skill in the art.

1. A mobile accommodation comprising a wall with a wall opening in which a window is arranged that hinges along a hinge side thereof, wherein said window is provided with closing means for keeping the window in a closed position, wherein said wall opening has an edge and is provided with a shoulder on said edge, wherein the closing means comprise a closure having a handle which is connected for rotation about a pivot axis to the window and having a protrusion, wherein said handle is displaceable between a first position round said pivot axis and a second position round said pivot axis, wherein said protrusion engages with said shoulder on said edge of said wall opening in a closing co-operation in said first position of said handle, wherein said protrusion disengages from said shoulder in order to release the window in said second position of said handle, wherein said pivot axis makes an obtuse angle with said window, which angle opens toward said hinge side of said window, wherein said handle is oriented substantially parallel to the window in said first position, and wherein said handle points at an acute angle toward said hinge side in said second position.

2. The mobile accommodation as claimed in claim 1, wherein the closure comprises a base part which is firmly connected to the window at a first interface, wherein the closure comprises a top part from which the handle extends, wherein the top part is connected for rotation about the pivot axis to the base part at a second interface, and wherein the second interface makes an acute angle with the first interface, which acute angle is at least substantially complementary to the obtuse angle of the pivot axis.

3. A mobile accommodation as claimed in claim 1, wherein the closure comprises manually releasable locking means which fix the closure in the first position.

4. A mobile accommodation as claimed in claim 1, wherein a casing frame surrounds the window, wherein the window is placed via the casing frame in the wall opening, and wherein the casing frame comprises the shoulder with which the protrusion of the closure is in engagement in a closed position of the window.

5. A closure of the type as applied in the mobile accommodation as claimed in claim 1.

6. A framed window for a mobile accommodation, comprising a casing frame with a window opening in which an openable window is mounted, which window is provided with the closure as claimed in claim 5, a protrusion of which is in engagement with a shoulder extending from the casing frame in a closed position of the window.

7. A mobile accommodation as claimed in claim 2, wherein the closure comprises manually releasable locking means which fix the closure in the first position.
